(19) United States
(12) Patent Application Publication
(10) Pub. No.: US 2008/0163295 A1
(43) Pub. Date: Jul. 3, 2008

(54) CONTENT PROVIDING DEVICE AND IMAGE OUTPUTTING DEVICE

(76) Inventors: Akihiro WATABE, Nara (JP); Yuichiro Aihara, Osaka (JP); Eiji Miyagoshi, Osaka (JP); Akihiko Otani, Osaka (JP); Takaaki Shingo, Hyogo (JP)

Correspondence Address: MCDERMOTT WILL & EMERY LLP, 600 13TH STREET, NW, WASHINGTON, DC, 20005-3096, US

(21) Appl. No.: 11/961,320

(22) Filed: Dec. 20, 2007

(30) Foreign Application Priority Data
Dec. 27, 2006 (JP) 2006-351854
Nov. 15, 2007 (JP) 2007-296624

(51) Int. Cl. G06F 3/00; H04N 7/173; H04N 5/66

(52) U.S. Cl. 725/39; 725/105; 348/739

(57) ABSTRACT

A content providing device of the present invention includes an access destination specifying portion for specifying an access destination; a control information obtaining portion for obtaining control information via a network from the access destination specified by the access destination specifying portion; a video content obtaining portion for obtaining video content available to an unspecified large number of people via a route other than from the access destination; and a video content displaying portion for displaying the video content by using the control information.

### CROSS REFERENCE TO RELATED APPLICATION

This application claims priority under 35 U.S.C. §119 on Patent Applications No. 2006-351854 filed in Japan on Dec. 27, 2006, and No. 2007-296624 filed in Japan on Nov. 15, 2007, the entire contents of which are hereby incorporated by reference.

### BACKGROUND OF THE INVENTION

1. Field of the Invention

The present invention relates to a device for providing content to the user, and more particularly to a device for combining together content which is obtained through network communications with a particular entity and content which is broadcast to an unspecified large number of people or content reproduced from a recording medium, and providing the combined content to the user.

2. Description of the Background Art

With the recent developments of the Internet, it is believed that there will be a growing demand for a cooperation between TV and the network. There is a system in the art where information is included in broadcast content in order to provide a cooperation with the network, as disclosed in Japanese Laid-Open Patent Publication No. 10-117332 (Patent Document 1), for example.

In the world of the Internet, video distributing websites are already in operation. Although they are built only on the network, the user can use them just as they watch TV while selecting a particular channel.

With a method where information is included in broadcast data as disclosed in Patent Document 1, a cooperation can be established only with network content items that are provided by broadcasting stations. This is not making good use of an advantage of the network, i.e., “being able to provide various types of services”.

Moreover, where a video is distributed via the network, the image quality is inevitably inferior to that of a broadcast video, and the video is more easily copied, thus raising copyright issues.

### SUMMARY OF THE INVENTION

The present invention makes it possible for the user to use broadcast content and packaged media content from network content. The broadcast content is not distributed from the network, but the existing broadcast content receiving scheme is used as it is, thus eliminating the need for the copyright control process, which is unique to the network.

With the use of the present invention, a user who is authorized to receive broadcast content can enjoy the same level of controllability and variety of services as those with video distributing services on the network, while obtaining broadcast materials of a much higher image quality than that in the prior art. Moreover, since content items are not distributed through the network, copyright issues will not arise and the amount of data will not increase.

With the present invention, which uses the same broadcast content receiving scheme as that in the prior art, a broadcasting station can use the existing system as it is and new services using the network can be produced freely.

The recording/reproduction device is provided with a simple mechanism, and complicated services are provided by network servers, whereby the system can very easily be expanded in the future.

### BRIEF DESCRIPTION OF THE DRAWINGS

FIG. 1 is a block diagram showing a general configuration of a video viewing system of a first embodiment.

FIG. 2 is a block diagram showing an internal configuration of a decoder shown in FIG. 1.

FIG. 3 shows an example of a format of a subpicture.

FIG. 4 is a diagram showing an example of how the display screen is divided.

FIG. 5 is a diagram showing an example of a format of control information.

FIG. 6 is a diagram showing an example of the display screen.

FIGS. 7A to 7F are diagrams each showing an example of control information for the display screen of FIG. 6.

FIGS. 8A and 8B are diagrams showing the display screen in a case where a CM portion of a TV program is replaced with other information.

FIG. 9 is a diagram showing an example of a format of CM information data.

FIGS. 10A and 10B are diagrams each showing an example of the display screen in a case where a DVD is reproduced.

FIG. 11 is a flow chart in a case where channels are linked with an external server.

FIG. 12 is a flow chart in a case where changes in data at the server are linked with TV broadcast channels.

FIG. 13 is a block diagram showing a general configuration of a video viewing system of a second embodiment.

FIG. 14A is a diagram showing an example of the display screen before a particular program is broadcast.

FIG. 14B is a diagram showing an example of the display screen after the particular program is broadcast.

FIG. 15 is a diagram showing a format of data sent from a server when recording of a program is programmed.

FIG. 16 is a diagram showing an example of information recorded together with broadcast stream data when a program is recorded.

FIG. 17 is a flow chart of a reproduction process.

### DESCRIPTION OF THE PREFERRED EMBODIMENTS

Embodiments of the present invention will now be described with reference to the drawings.

### First Embodiment

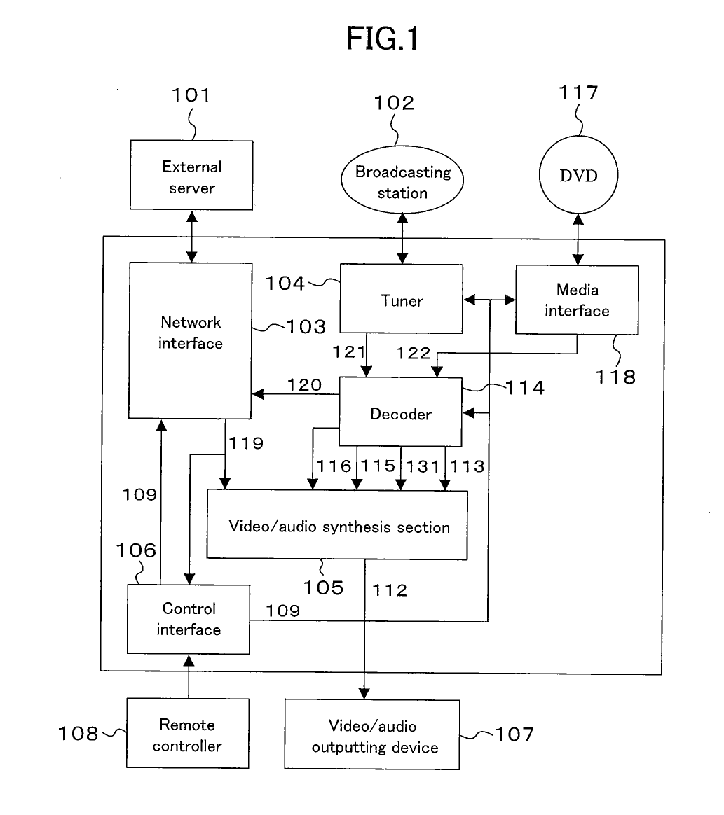

FIG. 1 is a block diagram showing a general configuration of a video viewing system of a first embodiment. The video viewing system of FIG. 1 is a system primarily for viewing broadcast content or content of a packaged medium such as a DVD. Although the system is herein assumed to be for viewing broadcast content and DVD content, the system of the present invention may be a system for viewing only one of them.

Before a detailed description thereof, the objective of the present system will be outlined. The present invention provides a system, in which high-quality video/audio content items such as broadcast content items and DVD content items can be used on various forms of services such as those found on the Internet. With the present system, information obtained from an external server via the network can be synthesized with broadcast content, DVD content, etc., and the synthesized content can be provided to the user, who can thereby obtain a wide variety of applications, which could not be obtained from conventional broadcasting services, and high-quality videos, which would not be obtained from conventional network services. In order to take advantage of this simple but effective integration, the present system is designed so that the decoder control and the overall control can be in a close cooperation with the network.

The video viewing system of FIG. 1 is connected to an external server 101, a broadcasting station 102 and a DVD 117, being sources of content.

Although only one external server 101 is shown in the figure for the sake of simplicity, it is typically any server capable of two-way communications via the Internet, or the like, and there are countless such servers around the world.

The broadcasting station 102 is an entity that broadcasts videos via terrestrial broadcasting, satellite broadcasting and cable TV, and there are many such entities although the number of such entities available varies from one area to another. Such a broadcasting station sends the same content item to an unspecified large number of people, and offers a high quality although it lacks interactivity.

The DVD 117 is typically an optical disc medium that is sold to an unspecified large number of people. It has a very high quality, and offers a high level of interactivity as opposed to broadcast content. However, it takes some time and labor to obtain content on such a medium.

Although the external server 101 of the present embodiment can also distribute video data, the quality is low because the video data is distributed via the network. Nevertheless, it provides two-way communications and offers a very high level of interactivity, and it is capable of distributing content to a particular individual user.

The video viewing system is capable of two-way communications with the external server 101 via a network interface 103. The video viewing system receives a video stream 121 from the broadcasting station 102 via a tuner 104.

The network interface 103, the tuner 104, a media interface 118 and a decoder 114 are controlled by a control signal 109 from a control interface 106. Alternatively, the network interface 103 can receive control information 119 for controlling the device from the external server 101, whereby the control interface 106 controls the tuner 104, the media interface 118 and the decoder 114 by using the control information 109 based on the control information 119.

The decoder 114 receives video data 121 and 122 from the tuner 104 and the media interface 118 and decodes the received data. Where broadcast content or DVD content is encrypted, information for decrypting the content can be obtained from the external server 101 via the network interface 103 and supplied to the decoder 114 via the control interface 106. The significance of such a function will later be discussed.

The decoder 114 outputs main video data 113, audio data 131, subpicture data 115 and subpicture area information 116, as a result of decoding the input streams 121 and 122.

The subpicture area information 116 represents a subpicture area that is intended to be an area for displaying a different image on a portion of the main video.

In a DVD, it is often the case that a plurality of sets of subtitles of different languages of different countries are provided while being multiplexed together for each language. These subtitles data can be separated as a subpicture from the main video. Normally, such a subpicture can be turned ON/OFF by the user. When it is turned ON, the subpicture is superimposed on a particular portion of the main video.

It is reasonable to believe that the subpicture area information 116 specifies such an area that does not substantially influences the viewing of the main video content. Therefore, it is believed that the area is one of the most appropriate areas for superimposing subordinate information on the main video.

The subpicture area information 116 is also intended to be used for synthesizing another image as will be described later. For example, a video/audio synthesis section 105 can detect the presence of horizontal black bars on top and bottom of the screen resulting from letterboxing, whereby the black-bar areas may be used as subpicture display areas.

The video/audio synthesis section 105 receives video and audio information from the decoder 114 and the control information 119 from the network interface 103 to synthesize and output the video and audio information.

More specifically, based on the control information 119, the area for displaying the main video 113 from the decoder 114 and the area for displaying the background image are determined, and data to be displayed in the subpicture area is determined. While the subpicture 115 from the decoder 114 is normally synthesized in the subpicture area, an image specified by the network interface 103 may be synthesized. The background image does not have to be a still image, but may be a moving image. Also with audio data, the audio data from the decoder 114 and that from the network interface 103 can be synthesized together with an appropriate ratio. For example, only the audio data from the external server 101 can be output without using the audio data from the decoder 114. Then, it is possible to, for example, watch a live coverage of a baseball game while listening to the commentary thereon from the external server 101 without using the commentary from the broadcasting station.

An important feature of the present invention is that the external server 101 can be responsible for such control operations.

The decoder 114 outputs stream reproduction information (information representing the state of decoding) 120 to the network interface 103. More specifically, the stream reproduction information 120 may be information indicating which chapter is being reproduced in the case of a DVD, and may be meta data in a broadcast stream in the case of broadcast content.

These meta data may be sent to the server 101, or application programs may be downloaded from the server 101 so that the control may be performed by the device.

Where data is sent to the server 101, there may arise copyright and security issues. Therefore, it is preferred that data is sent to the server 101 after making the decision on whether the data is one that may be sent thereto.

Where programs are downloaded from the server 101, it is necessary to take security measures, e.g., to limit the execution of programs. Methods for limiting the functions of programs are not essential to the present invention and will not therefore be discussed herein, but such limitation can be achieved by using security measures that are commonly used in the art of computers.

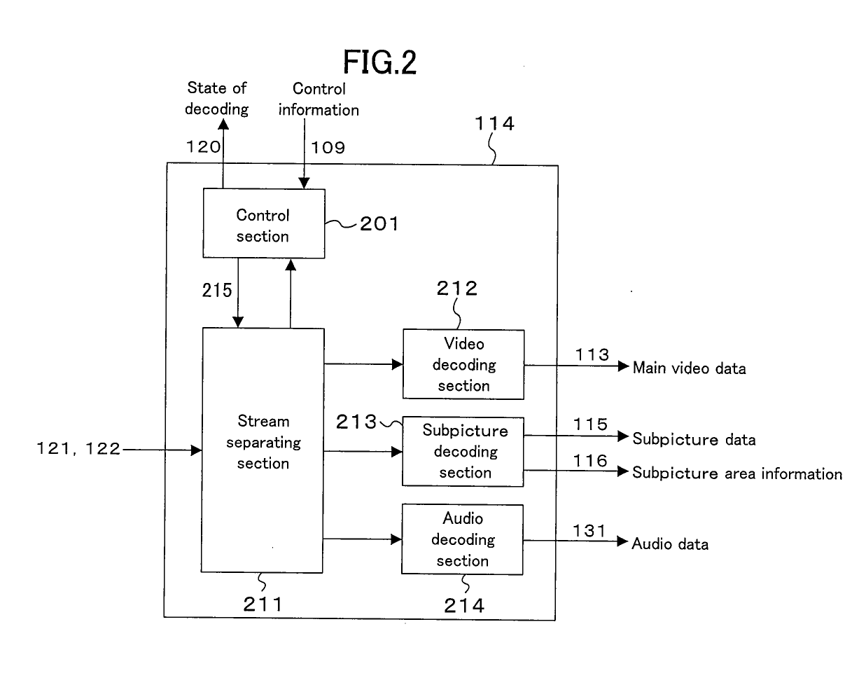

FIG. 2 shows an example of an internal configuration of the decoder 114. The decoder 114 decodes a stream from an ordinary DVD, of the like. Recent digital broadcasting techniques also generally use a format in which video and audio are multiplexed together. Particularly, with DVDs, subpicture data such as subtitles data are also multiplexed.

The input streams 121 and 122 are separated by a stream separating section 211 into a video component, an audio component and a subpicture component. The video component is decoded through a video decoding section 212 and output as the main video data 113. The audio component is decoded through an audio decoding section 214 and output as the audio data 131. The subpicture component is decoded through a subpicture decoding section 213 and output as the subpicture data 115 and the subpicture area information 116.

The subpicture data 115 is synthesized with the main video data 113 according to the subpicture area information 116 in the subsequent video/audio synthesis section 105, and the synthesized video is displayed on the screen by a video/audio outputting device 107. Thus, the subpicture data 115 from the decoder 114 is normally synthesized and displayed in the area specified by the subpicture area information 116. In contrast, the system of the present embodiment is characterized in that other images, e.g., those obtained from the external server 101 via the network interface 103, can be synthesized and displayed instead of the subpicture data 115. This will now be described in detail.

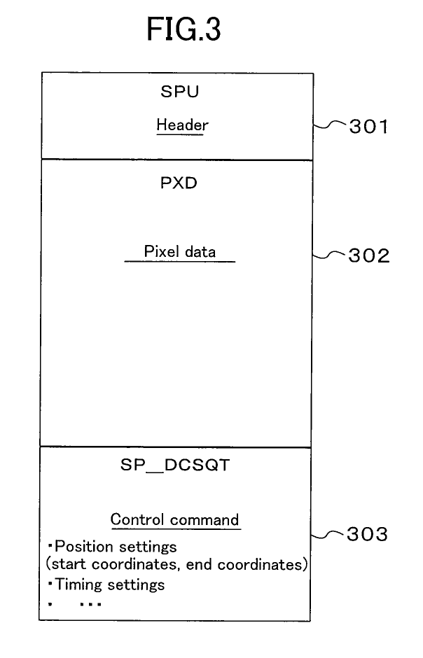

A subpicture in a format as shown in FIG. 3 is multiplexed in the streams 121 and 122 input to the decoder 114. The subpicture shown in FIG. 3 is composed of a header 301, pixel data 302 and a control command 303. The subpicture is separated from the input streams 121 and 122 by the stream separating section 211, and supplied to the subpicture decoding section 213. The subpicture decoding section 213 decodes the subpicture, outputs the pixel data 302 as the subpicture data 115, and outputs the control command 303 as the subpicture area information 116. The subsequent video/audio synthesis section 105 synthesizes other images, e.g., images obtained from the external server 101 via the network interface 103, instead of the subpicture data 115, with the main video data 113 by using the display coordinates information of the subpicture area information 116. The synthesized video is displayed on the screen by the video/audio outputting device 107. The decoder 114 and the video/audio synthesis section 105 together form the image outputting device of the present invention. The decoder 114 and the video/audio synthesis section 105 may be formed on the same LSI chip, or on different LSI chips.

A control section 201 of the decoder 114 shown in FIG. 2 also serves to extract the stream reproduction information (information representing the state of decoding) 120, such as the information indicating which part of the stream is being reproduced or the information for controlling the timing in the stream, as will be described later. For example, the control section 201 extracts information such as chapter points with a DVD, and extracts timing information with broadcast content in a case where the broadcasting station specifies appropriate timing information carried on the stream.

Moreover, in the present system, license information for decrypting encrypted stream data can be obtained via the network. In such a case, the control section 201 sends license information 215 to the stream separating section 211. Moreover, it is also possible to realize an embodiment where only a portion of a stream is encrypted, whereby the information can be used only when a particular server is accessed.

With a DVD, it is also necessary to provide the function for special reproduction operations, which can also be handled by the control section 201.

Next, the operation of the system of the present embodiment and examples of how different functions thereof are used will be described.

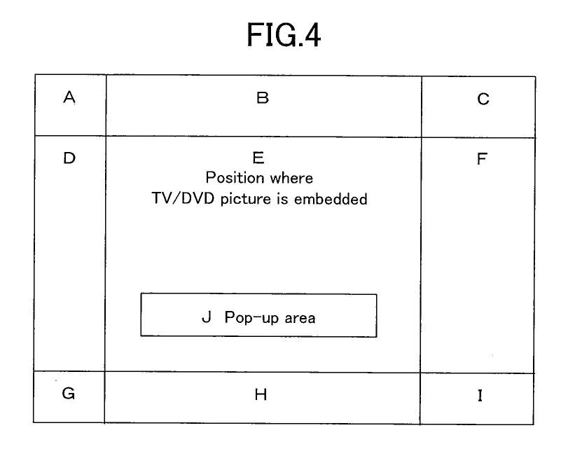

FIG. 4 is a diagram showing an example of areas of image produced by the video/audio synthesis section 105. In this example, the screen is divided into nine areas A to I, wherein a TV picture or a DVD picture is displayed in the central area E. Data sent from the external server 101 are displayed in other areas. A pop-up area J is also provided. The pop-up area J can be provided in any of the nine areas A to I. The position of the pop-up area J shown in FIG. 4 is merely illustrative, and the position is determined depending on the main content video of broadcast content or a DVD, but not determined via the network.

A plurality of areas (e.g., the three areas of A, B and C) may be combined into a single area. The example of area division (A to I) shown in FIG. 4 is used herein as one of the simplest patterns. Other layout patterns will not change the substance of the present invention.

In the present invention, a TV picture or a DVD picture is the primary object that should stand out the most. Therefore, it is not appropriate that the position where the TV picture or the DVD picture is embedded changes frequently.

With web pages on the Internet, it is often the case that pieces of display data being downloaded are temporarily laid out and the layout is changed dynamically as the download of the display data proceeds. With the present invention, however, it is preferred that the position where the TV picture is embedded is not moved until the overall layout is set. For example, when a server is switched to another, the position where the TV picture is embedded should not be changed until the embedded TV picture is fixed.

The position where the TV picture is embedded should not be changed even by using a scrolling portion, or the like. The system will be easier to use if the scrolling is allowed only in portions other than where the TV picture is embedded, while also limiting the area over which the screen can be scrolled to only one section.

Improvements may be made by, for example, using animated effects when the layout is changed, and determining the settings according to each device, e.g., limiting the frequency with which the screen position can be changed. Such effects themselves may be specified by the server.

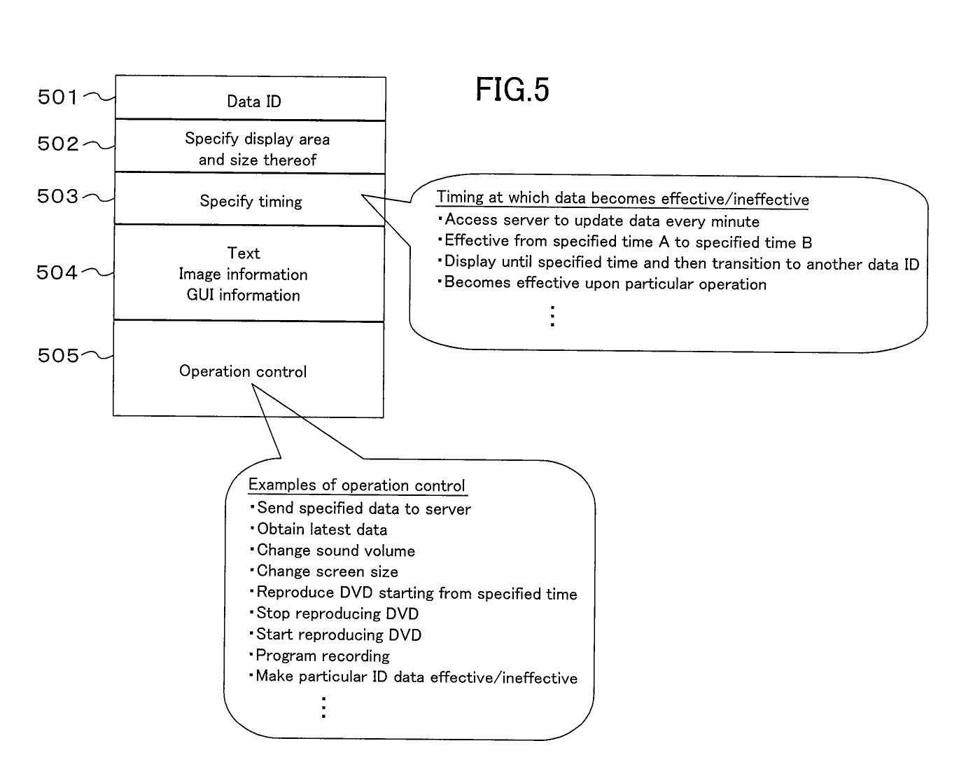

Next, the control information 119 sent from the external server 101 will be described in greater detail. FIG. 5 shows an example of a format of the control information 119.

The control information 119 sent from the external server 101 is composed of data ID 501, information 502 specifying the display area and the display size, timing specifying information 503, display information 504 for the specified area, and operation control information 505.

The information 502 specifies one of the display areas illustrated in FIG. 4 and specifies the size of the area.

The display information 504 is basically image data or text data to be displayed in the area. The image may be a still image or a moving image. The display information 504 also includes GUI parts, e.g., control buttons and selection buttons, such as those that are often seen on web pages. Data representing the action to be taken when these buttons are pressed is also sent as the operation control information 505.

The timing specifying information 503 includes information representing the timing at which data is updated or that at which data becomes effective in each area, whereby the content of each area can be changed based on the time, the scene being reproduced, meta data or a user operation. More specifically, when the user is watching a broadcast program, the system may produce background data that is effective only in a particular period of time or data that is effective only during the period of a CM, and when the user is watching DVD content, the system may produce data that is effective only when the user is watching a particular scene, and data that is effective only while the user is switching channels from one to another with a remote controller. The system may give the server information on the timing at which data is to be newly obtained.

The operation control information 505 may include control information for operations that can be done with a remote controller. The operations include, for example, controlling the channel, controlling the volume, pausing DVD reproduction, and jumping to a particular time.

Allowing a remote controller to be controlled based on data coming from outside raises security issues. Therefore, it is preferred to provide a function of authenticating reliable servers, a function of prompting the user to decide whether or not to give permission, or a function of explicitly prohibiting the server from operating a remote controller.

Aside from the GUI, the operation control information 505 may include data that only include the operation of selecting a particular channel without the use of a GUI.

Examples of attractive applications that can be created using such mechanisms as described above will be shown below. What is shown below is not a function of a device, but what is provided by a particular external server 101. A feature of the present invention is that each of the large number of external servers 101 existing around the world can provide a unique application.

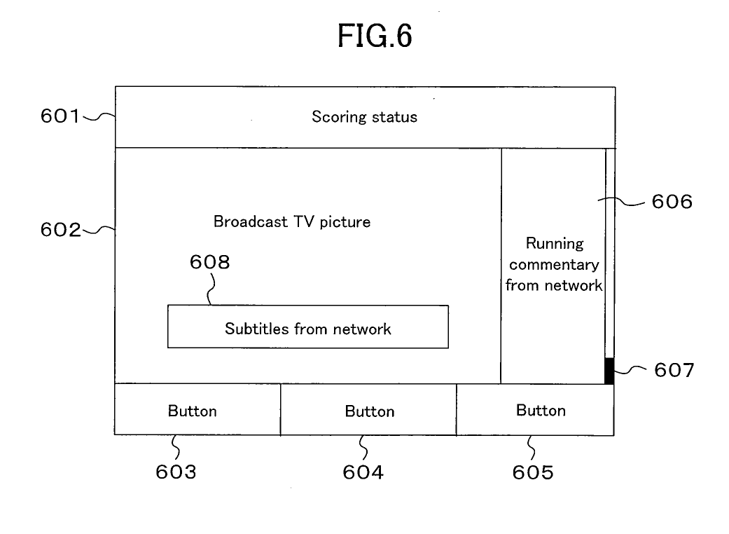

FIG. 6 shows an example of the display screen of the system of the present embodiment, when particular information is obtained from the external server 101 via the network. More specifically, this example is directed to a broadcast event that is scored by judges, such as a live coverage of a boxing match. With a live coverage of such an event that is scored by judges, some users may wish to score the contenders and then to know how other people have scored the contenders in real time. Conventionally, such a system is quite difficult to realize unless a broadcasting station offers such a function. With the system of the present embodiment, a user can create an application as shown in FIG. 6 and put it on the external server 101, thus simply realizing such a function.

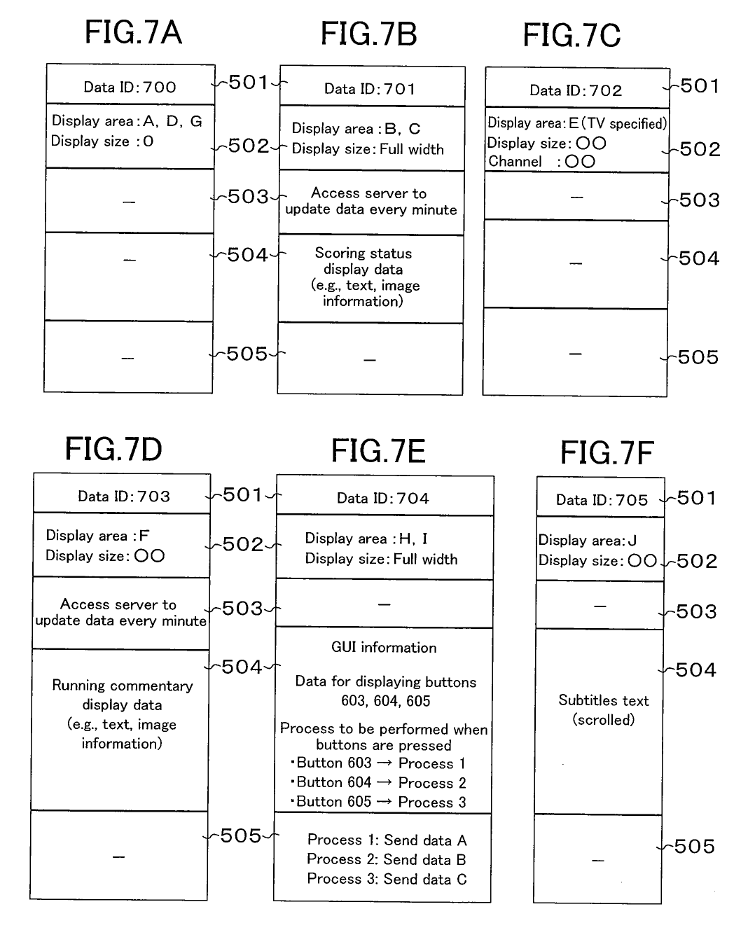

When the external server 101 is accessed by the video viewing system of the present embodiment, the control information 119 as shown in FIGS. 7A to 7F are sent from the external server 101. The format of these control information is the same as that shown in FIG. 5. A display screen as shown in FIG. 6 is obtained according to the control information 119. It is assumed herein that the display screen of FIG. 6 is divided into nine areas (A to I) as shown in FIG. 4.

The control information (data ID: 700) shown in FIG. 7A is control information regarding the display areas A, D and G. The three display areas A, D and G are specified in the display area/size specifying information 502. In such a case where a plurality of display areas are specified, the display areas are handled as a single display area. Moreover, a display size of zero is specified in the display area/size specifying information 502. Thus, the display areas A, D and G are not displayed on the screen.

The control information (data ID: 701) shown in FIG. 7B is control information regarding the display areas B and C. The two display areas B and C are specified in the display area/size specifying information 502. Therefore, the display areas B and C are handled as a single display area. Moreover, it is specified in the display area/size specifying information 502 that the entire width of the screen is used for this area. Therefore, the display areas B and C are displayed on the screen as a display area 601 of FIG. 6. Moreover, it is specified in the timing specifying information 503 that the server is accessed to update data every minute. The external server 101 is totalizing the scores of various people in real time to produce scoring status display data, and the scoring status display data is transmitted from the external server 101 as the display information 504 of the control information and is displayed in the area 601 of the screen of FIG. 6. Based on the timing specifying information 503, the scoring status display data displayed on the display area 601 is updated every minute. It is understood that the data updating interval is not limited to one minute, but may be any other suitable period of time.

The control information (data ID: 702) shown in FIG. 7C is control information regarding the display area E. In the display area/size specifying information 502, the display area E is specified as an area for the TV picture. The display size and the channel are specified in the display area/size specifying information 502. Therefore, the display area E is displayed on the screen as the display area 602 of FIG. 6. The broadcast TV picture of the channel specified in the display area/size specifying information 502 is displayed in the display area 602 of FIG. 6.

The control information (data ID: 703) shown in FIG. 7D is control information regarding the display area F. The display area/size specifying information 502 specifies the display area F, and the display area F is displayed on the screen as a display area 606 of FIG. 6. Moreover, it is specified in the timing specifying information 503 that the server is accessed to update data every minute. The external server 101 has a portion such that the creator can receive commentary on the status of the match, and produces text- or image-based running commentary display data based on the received commentary. The running commentary display data is transmitted from the external server 101 as the display information 504 of the control information and is displayed in the area 606 of the screen of FIG. 6. The commentary sending function can be provided in the present viewing system, it is herein assumed that a web page for submitting comments is separately provided because it is difficult to type text on a regular TV set. This has become common with BBSes on the Internet. Based on the timing specifying information 503, the running commentary display data displayed in the display area 606 is updated every minute. It is understood that the data updating interval is not limited to one minute, but may be any other suitable period of time.

The control information (data ID: 704) shown in FIG. 7E is control information regarding the display areas H and I. The two display areas H and I are specified in the display area/size specifying information 502. Therefore, the display areas H and I are handled as a single display area. Moreover, it is specified in the display area/size specifying information 502 that the entire width of the screen is used for this area. Therefore, the display areas H and I are displayed on the screen as display areas 603, 604 and 605 of FIG. 6. The display information 504 includes, as GUI information, display data for buttons 603, 604 and 605 and data representing the action to be taken when these buttons are pressed. Moreover, the operation control information 505 specifies the action to be taken when these buttons are pressed. Thus, as shown in FIG. 6, the buttons 603, 604 and 605 for allowing the viewer to do simple scoring are displayed on the display screen. The viewer can use the buttons 603, 604 and 605 to indicate which contender the viewer thinks is leading or to indicate that the viewer thinks neither is leading the other. When a button is pressed by the viewer's operation of the remote controller, information according to the pressed button is sent to the server 101. The server 101 totalizes the transmitted scores to determine which contender is being thought by more people to be currently leading, and displays the results in the area 601. The device fetches the display data for the area 601 from the server 101 every minute as described above, the user can see the latest scores.

The control information (data ID: 705) shown in FIG. 7F is control information regarding the display area J. As shown in FIG. 4, the display area J is a pop-up area. Moreover, the display information 504 includes a subtitles text and specifies that the subtitles text is scrolled. Thus, subtitles information and various comments from the network can be displayed in an area 608 being a portion of the broadcast TV picture screen 602 as shown in FIG. 6. As already described above, since the subpicture area is obtained by the decoder 114, it is possible to display some information as if it were subtitles in an area where the subpicture would normally be displayed, as long as the area is appropriate. Such information may be displayed in an area other than the subpicture area if the user has selected to show ordinary subtitles, and in the subpicture area if the user has selected not to show ordinary subtitles.

In the system of the present embodiment, the server 101 and the broadcasting station 102 do not need to be related to each other. While the broadcasting station 102 broadcasts its programs using their existing infrastructures, the server 101 can make an application using the broadcast content as a material. Thus, with the same device and the same broadcast content, it is possible to provide a wide variety of services depending on the application of the server 101, indicating the great potential ability of the present system. Moreover, it is possible to realize a totally different screen layout or interface by changing the server 101 without changing the device. For example, processes that need no network intervention, such as the function of switching to a full screen mode from a normal mode where a background image is used, and the operation of turning the power OFF and adjusting the volume, can easily be realized by adding appropriate GUI parts. Since the main video is not distributed from the server 101, the present system will not decrease the network bandwidth. Since it is only the user having a tuner and being able to normally receive the broadcast programs who can view the TV programs on the present system, the copyright will not be infringed.

The above example is an application that can be realized while the broadcasting station 102 does not at all have to take the presence of the server 101 into consideration. With the system of the present embodiment, it is possible to realize other characteristic applications if the broadcasting station 102 cooperates with the server 101.

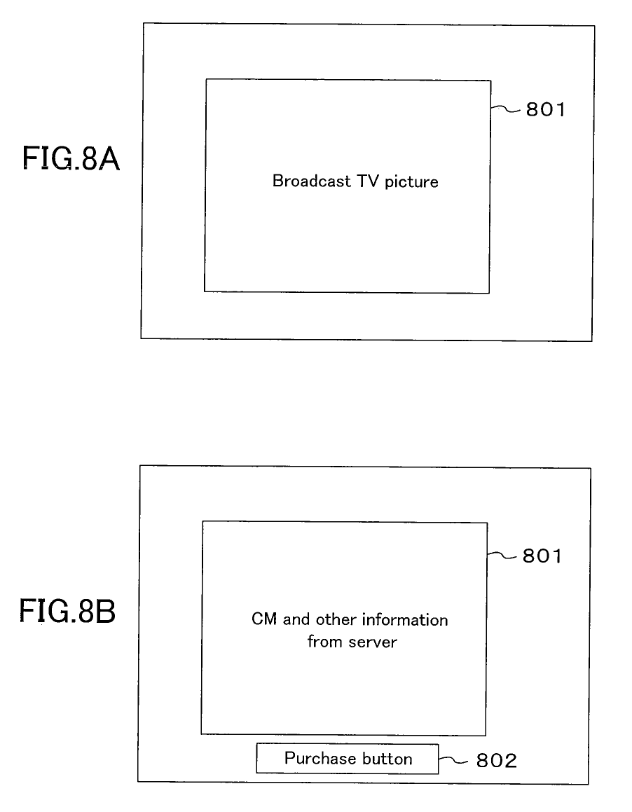

FIGS. 8A and 8B show such an example, where the CM portion of a TV program is replaced with other information. Since this changes the broadcast TV data, it is a function that cannot be realized without involving the broadcasting station 102. The broadcasting station 102 sends the TV broadcasting stream while including therein information (herein, “CM information data”) based on which replaceable data (herein, a CM) can be separated from non-replaceable data (herein, main content). Then, there may be provided such a mechanism that only a particular server is allowed to replace the replaceable data with other data.

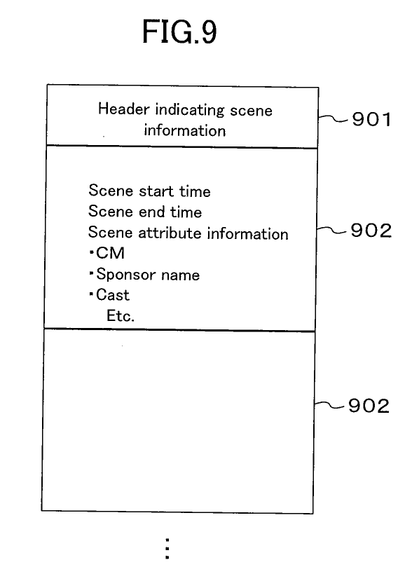

The broadcast stream sent from the broadcasting station 102 includes CM information data as shown in FIG. 9. The CM information data is composed of a header 901 indicating that it is scene information, and scene information 902. A piece of scene information 902 is provided for each scene included in the broadcast stream. Each piece of scene information 902 includes the start time and the end time of the scene. As attribute information of the scene, it also includes right information indicating whether the scene is a CM, the name of the sponsor, the cast, etc. Referring to the right information of each piece of scene information 902, it is possible to determine whether the scene is replaceable data (a CM) or non-replaceable data (main content). The CM information data may be encrypted, and the broadcasting station 102 may give the key needed for decrypting the data is passed only to contracted servers. The user can access a server that is contracted with the broadcasting station to decrypt the CM information data so that data sent from the server can be displayed in the main video area during the period of the CM. A different encryption key may be used for each sponsor, so that the encryption key can be used to replace only the CM of the particular sponsor with other information. In such a case, encryption is done uniquely by each sponsor so that the information becomes available to the user only when the user accesses the website of the particular sponsor.

FIG. 8A is a diagram showing an example of the display screen where a normal TV program is displayed. The broadcast TV picture is displayed in an area 801 (corresponding to the area E of FIG. 4). When the CM period starts, information different from the broadcast TV picture is displayed in the area 801 as shown in FIG. 8B. In FIG. 8B, an advertisement of a different product from the external server 101 is displayed in the area 801, and a purchase button 802 as a GUI part is also displayed. Alternatively, the user can select another channel, a news screen, a stock chart, or the like, during the CM period. The meta data of the broadcast data may be sent to the server 101, which has been given permission, so that the server 101 can display an appropriate advertisement.

Thus, the broadcasting station 102 can create a business model in which the broadcasting station 102 sells the server 101 the right to replace CMs, wherein the server 101 can profit from displaying an advertisement appropriate for the user of the server 101. It is possible to display a button for purchasing a product linked with the advertisement, and it is possible to offer other services such as showing various types of news during the CM periods. It is possible to show images of other channels only during the CM periods.

The description above has been directed to a case where the user mainly receives broadcast TV programs. Next, an operation linked with DVD reproduction will be described. Generally speaking, this is an embodiment where a DVD picture is displayed instead of the broadcast TV picture. In the case of DVD reproduction, special reproduction operations and the function of jumping to a particular scene can be used, which are not realized with TV broadcasting, and it is therefore possible to realize an application that makes use of such characteristics.

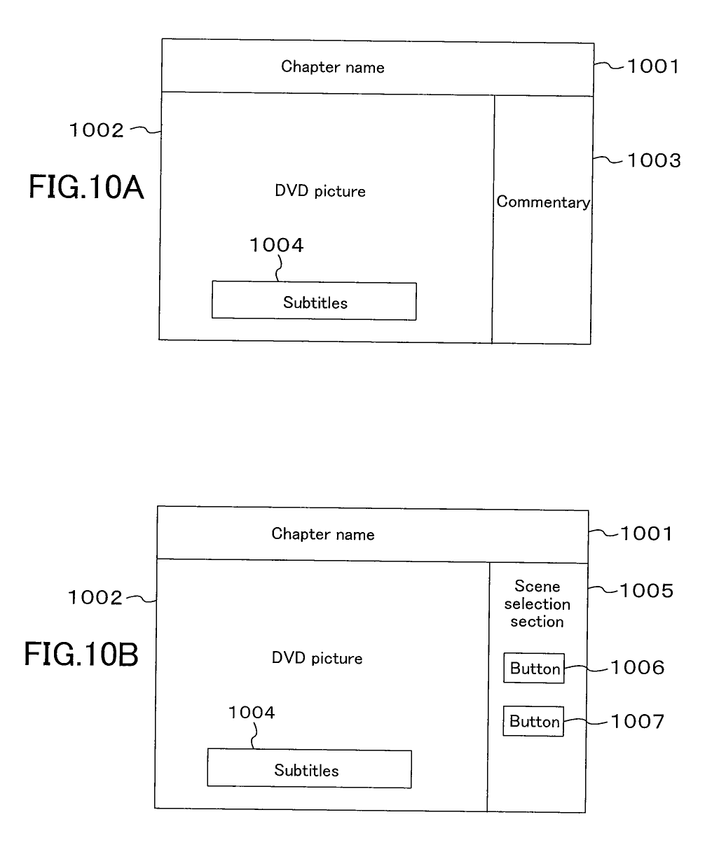

FIGS. 10A and 10B each show an example of the display screen in the case of DVD reproduction. Generally speaking, in the case of DVD reproduction, there are two states, i.e., a state where “the server cooperates with the DVD reproduction wherein the server is subordinate to the DVD reproduction”, and a state where “a DVD is reproduced according to information from the server”. In either case, the user selects a suitable server, independently of the DVD. Specifically, various DVD-reproducing web pages have been set up on the server 101, so that the user can selectively access a web page that the user likes. The user accesses the content-reproducing web page, and specifies on the web page an item of DVD content to be reproduced. Alternatively, the system may be provided with a function of automatically extracting content identification information written on a DVD and sending the extracted information to the server 101. Then, the control information 119 of the DVD content-reproducing web page is sent from the server 101. Based on the control information 119, a screen as shown in FIG. 10A or FIG. 10B, for example, is displayed.

FIG. 10A is a diagram showing an example of the display screen when the user is viewing a DVD reproduced as the user presses the play button on a remote controller 108. The reproduced DVD picture (main video) is displayed in an area 1002 of FIG. 10A, and the subtitles (subpicture) are displayed in an area 1004. Various images based on the control information 119 from the server 101 are displayed in areas 1001 and 1003. A commentary that is suitable for the scene being currently viewed by the user is supplied from the server 101 and displayed in the right-side area 1003. In order to realize this process, the scene of the DVD content and the commentary data can be associated with each other in the control information 119 regarding the area 1003. Based on the reproduction time information, the chapter information, etc., received from the decoder 114, the network interface 103 produces and displays images suitable for the areas 1001 and 1003 of the display screen.

Thus, there is realized an application in which as the user reproduces a DVD, a commentary associated with the scene being currently viewed is automatically displayed. Even if the user fast-forwards the DVD or jumps to a different chapter, it is possible to select from the server 101 and display an appropriate image by using the time information, or the like, of the scene being currently reproduced.

In order to realize a completely linked operation, the server 101 needs to know which DVD is being currently reproduced. This can be achieved by prompting the user to identify the DVD upon access to the server 101, or by using identification information if any of such information is written on the DVD.

The subtitles (subpicture) displayed in the area 1004 may be replaced with another image, e.g., an image obtained from the external server 101 via the network interface 103. Moreover, different DVD commentaries and different subtitles may be used in a special reproduction operation and in a normal reproduction operation. For example, in a fast-forward operation, a digest-version commentary may be used. A commentary may be transitioned to the next commentary with a scrolling visual effect, for example, as the DVD is being reproduced, instead of simply switching to the next commentary.

FIG. 10B is a diagram showing an example of the display screen in a case where the DVD reproduction is controlled while the server 101 provides the GUI. The area 1002 of FIG. 10B is an area for displaying the reproduced DVD picture (main video), and the area 1004 is an area for displaying the subtitles (subpicture). Areas 1001 and 1005 are areas for displaying various images based on the control information 119 from the server 101. The area 1005 is an area for displaying a scene selection section. A plurality of reproduction-controlling GUI buttons 1006 and 1007 are displayed in the area 1005. Each of the GUI buttons 1006 and 1007 is assigned an operation of controlling the DVD reproduction (e.g., when a button is pressed, the reproduction may start from a particular point in time). Alternatively, the buttons may be assigned a reproduction operation, a jump operation, a reproduction repeating operation, etc., as with a playlist. Such buttons can be used in such an application where a DVD is reproduced so as to show a string of highlights of the DVD content.

As described above, with the system of the present embodiment, it is possible to realize an effect of extending the menus of conventional DVD players. It is understood that the function of FIG. 10A and that of FIG. 10B can be realized on a single display screen.

Although the system described above can be used both with a broadcast TV picture and a reproduced DVD picture, the present invention can be applied to a system that can be used only with one of them.

Next, a function of selecting a TV channel will be described.

As shown in FIG. 1, the user operates the present system by using the remote controller 108. Each channel button on the remote controller 108 is assigned an address (URL) to a particular piece of information on the external server 101.

FIG. 11 shows an operation flow in a case where channels are linked with the external server 101.

First, in step ST1101, information is obtained from a specified server 101. In this information-obtaining process, information useful in selecting a channel (e.g., information on the broadcasting service areas) may be additionally sent to the server 101. While the server 101 sends out various pieces of control information data 119 as described above, it is assumed that the control information data 119 also includes data that specifies a channel number.

Then, in step ST1102, a channel specified by the server 101 is selected.

Lastly, in step ST1103, the broadcast picture and data from the server 101 are synthesized together and displayed on the screen.

As seen from the user, an intended image can be obtained by pressing a particular button on the remote controller 108, irrespective of whether data are transmitted via the server 101.

Where the response from the server 101 is slow, it is preferred that something is displayed on the screen by one way or another, e.g., by displaying a default image, by showing the previously-watched program in a full-screen mode, or by using the previous layout. Where the user was already watching a TV program, it is preferred to show the TV program at the same position until the layout is fixed.

If the server 101 does not specify a channel, a previous program may be displayed.

Where the entire display screen is filled with data sent from the external server 101 via the network, it is of course not necessary to switch to another channel.

By further developing such a channel switching function, it is possible to realize, for example, a server application that automatically switches to a program that is currently being watched by most users, and a server application for selecting programs belonging to a particular genre. With a similar mechanism, it is possible to impose viewing restriction for children, e.g., prohibiting viewing of broadcast content in particular periods of time. With a server whose main function is only the channel selection, it is also effective to always show TV programs in a full-screen mode.

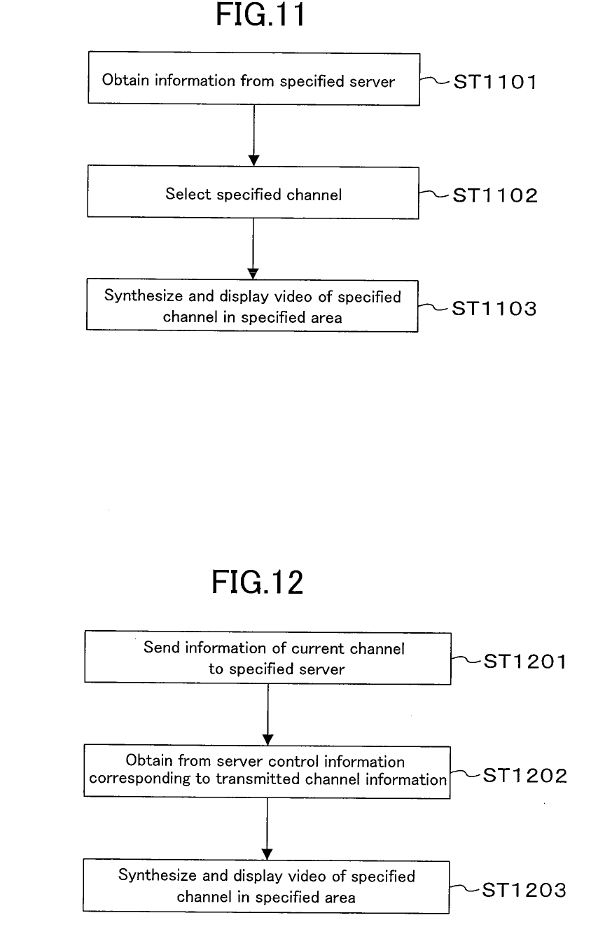

FIG. 12 shows an example where changes in data at the server are linked with TV broadcast channels.

First, in step ST1201, when a server 101 is specified, current channel information is sent to the server 101. In this process, information on the broadcasting service areas, EPG information, etc., may be sent at the same time. According to the received information, the server 101 prepares the control information 119 that deem to be suitable for the program. In step ST1202, the control information 119 is obtained from the server 101. Then, in step ST1203, based on the control information 119 from the server 101, the broadcast TV picture is synthesized and displayed.

The server 101 may display an advertisement that is decided to be suitable for the program being currently viewed by the user, or in some other cases may provide license information that is necessary for receiving the program of the channel. Moreover, a simple audience rating survey can be done. When sending license information, it is of course preferred that the broadcasting station 102 and the server 101 are contracted with each other and the server 101 has a contract with each user. In other words, there may be an embodiment where user authentication is a responsibility of the server 101, and the broadcasting station 102 does not make a contract with individual users. In such an embodiment, the server 101 may be considered to be serving a role of a local broadcasting station.

There are finer points on the operation of the system that should be discussed.

As described above, the size of the area in which the TV picture is embedded (the area E o FIG. 4) is specified by the network (on the server 101 side). It is very inconvenient if the size and position change frequently. This may apply when a URL is switched to another. Therefore, it is preferred that changing the size or position of the area in which the TV picture is embedded is allowed only after network data are completely set. It is also preferred that after a change is made, no changes are made at least for a few minutes. It is also preferred that a change is made at a scene change, for example. Such additional restrictions may be imposed. With recent Internet browsers, a page starts to be displayed as soon as portions of the page data are set, whereby the layout later changes as more of the data are set. This is not very suitable for an embedded broadcast picture or an embedded DVD picture, and changes in the size and position of the area in which the TV picture is embedded should be controlled separately from the timing at which the TV picture changes.

As described above, the present embodiment provides a device with a relatively simple configuration that can be controlled by the server, whereby it is possible to realize a wide variety of applications. The broadcasting station may take those applications into consideration, but a particular advantage is that various applications can be made without making any changes to existing content distributing schemes such as broadcasting stations and DVDs. Particularly, in view of the recent developments of the Internet, there is an environment enabling the realization of various ideas at low cost, and if there is a support for a device as that of the present embodiment, it is possible to provide a large number of applications at low cost. Moreover, not only companies but also ordinary users can possibly provide services. Thus, it is believed that the present embodiment provides an environment suitable for the fusion of the network and the broadcasting.

### Second Embodiment

While the first embodiment is directed to a system for receiving broadcast programs in real time, an even more convenient system can be provided by applying the present invention to a recording device.

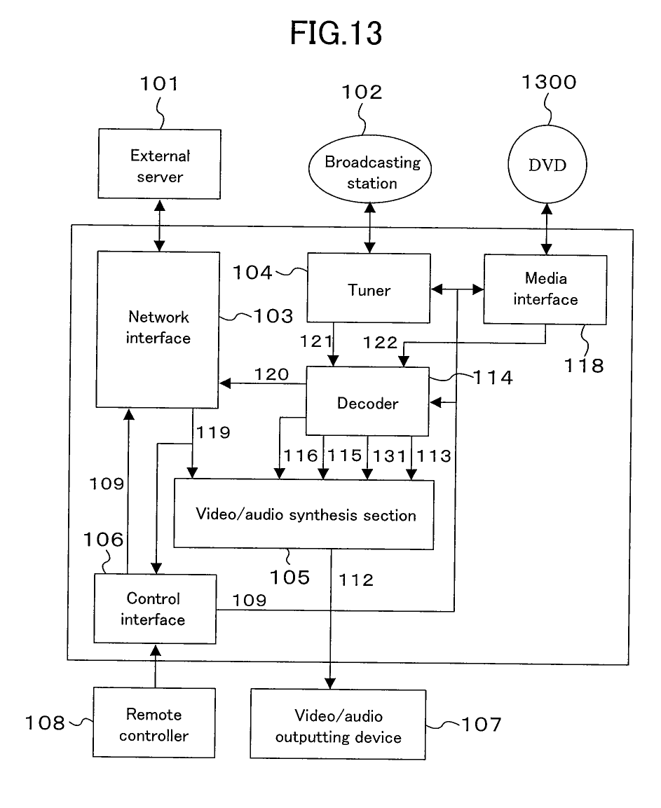

FIG. 13 is a block diagram showing a general configuration of a video viewing system of a second embodiment. The system of FIG. 13 includes an HDD 1300 instead of the DVD 117 of FIG. 1. Other elements are the same as those of the system of FIG. 1. Broadcast data from the tuner 104 can be recorded to the HDD 1300, and recorded data can be reproduced from the HDD 1300. An encoder may be provided separately so that the decoded picture is recoded after being encoded.

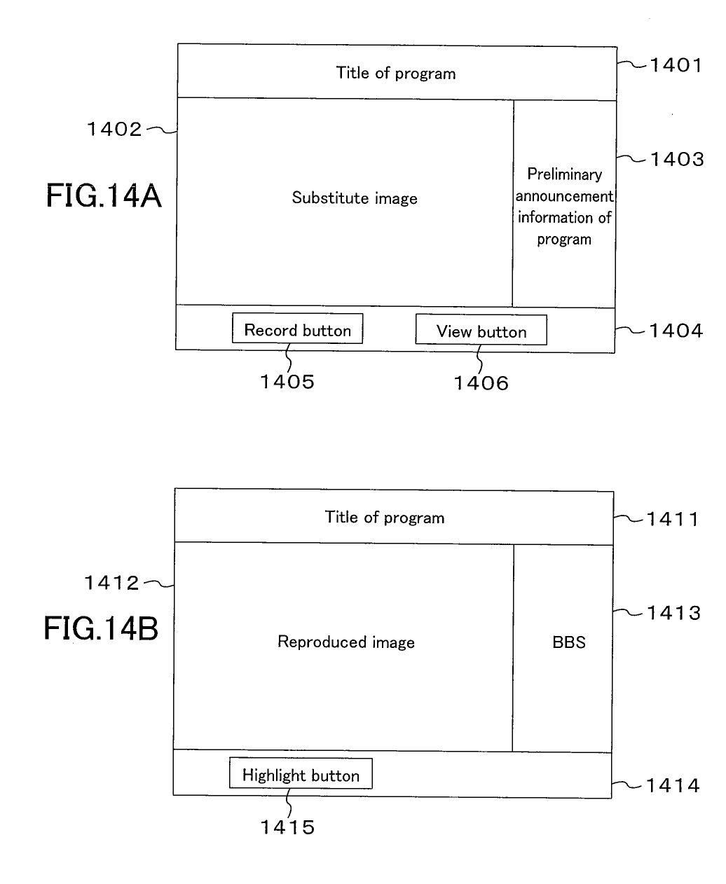

The operation of the present system is the same as that of the first embodiment, except for the recording function and the function of reproducing recorded videos, and only those new functions will be described below. In the present system, the external server 101 is responsible for a particular TV program, and has information such as the broadcast time of the particular TV program. When the external server 101 is accessed, it is determined that the broadcast of the particular TV program has started. This is shown in FIGS. 14A and 14B.

FIG. 14A is a diagram showing an example of the display screen before the broadcast starts. Since the broadcast has not started, the broadcast TV picture is not displayed in an area 1402 of FIG. 14A, but a substitute image is displayed based on the control information 119 from the server 101. The substitute image shows the broadcast time of the program, etc. The title of the program and the preliminary announcement information of the program are displayed in areas 1401 and 1403, respectively, based on the control information 119 from the server 101. A record button 1405 and a view button 1406 are displayed in an area 1404 based on the control information 119 from the server 101.

It is characteristic that the record button 1405 is displayed. If the record button 1405 is pressed, the recording process section of the HDD 1300 fetches the time information of the network interface 103, and the device is programmed to start recording the program at the specified time. Thus, the programmed recording function is provided by the external server 101. The start time can be specified by the external server 101. However, if the broadcasting station 102 is involved to cooperate with the system, the start time may be determined based on the meta data in the broadcast stream, accommodating the possibilities for changes in the broadcast time. The user can program the system to record the program by pressing the record button 1405.

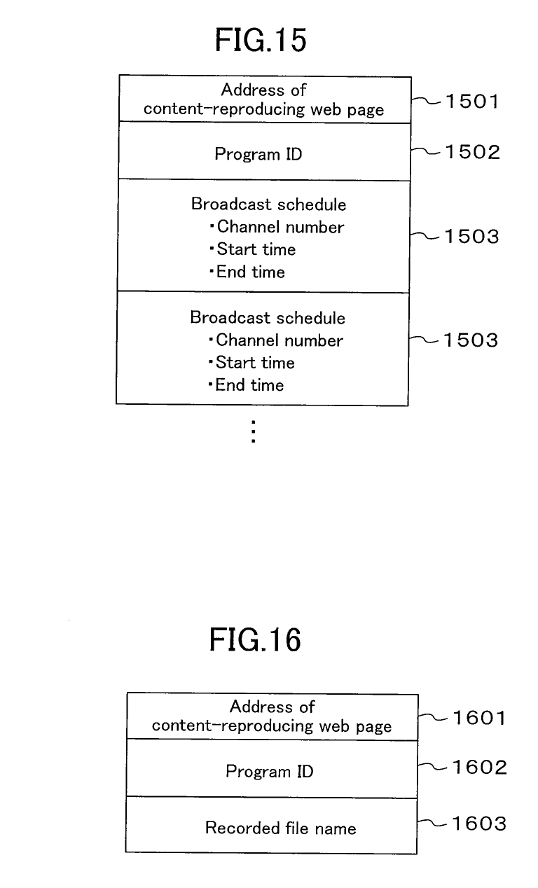

Moreover, when the record button 1405 is pressed, information indicating the pressing of the button is sent to the external server 101 via the network interface 103. In response to this, the external server 101 transmits data as shown in FIG. 15 to the network interface 103. The data includes an address 1501 of the content-reproducing web page, a program ID 1502, and a broadcast schedule 1503.

The program ID is a number assigned by the server to each program so that a plurality of programs can be managed by a single server. After the broadcast is over, the administrator of the server analyzes the program to which the ID has been assigned to create a suitable content-reproducing web page.

The broadcast schedule 1503 includes the channel number, the start time, and the end time. There may be only one broadcast schedule 1503, or a plurality of broadcast schedules 1503. A plurality of broadcast schedules 1503 may be included, for example, in a case where programs are recorded while cutting off CM portions, and in a case where the channel changes during a broadcast. In the present system, it is possible to record everything except during CM periods if the CM periods are known in advance. Of course, such information on the CM periods may be used as a privilege that is given only when recording a program via a server 101 that has been authorized by the broadcasting station 102. Then, it is possible to realize a system where the broadcasting station 102 can profit from contracting the server 101, and the server 101 can profit from contracting the individual users.

When recording broadcast stream data from the tuner 104, the HDD 1300 records data as shown in FIG. 16 associated with the broadcast stream data. An address 1601 of the content-reproducing web page and a program ID 1602 of FIG. 16 are obtained by using the information (1501 and 1502 of FIG. 15) sent from the server 101.

FIG. 14B is a diagram showing an example of the display screen after the broadcast is over. If there exists recorded data, the display will be as shown in FIG. 14B. An area 1412 of FIG. 14B is an area for displaying a reproduced picture. The title of the program and a BBS are displayed in areas 1411 and 1413, respectively, based on the control information 119 from the server 101. A highlight button 1415 is displayed in an area 1414 based on the control information 119 from the server 101.

When the highlight button 1415 is pressed, the system reproduces only the highlight portion of the recorded program. This can be realized by controlling the reproduction time of the reproduction process section of the HDD 1300 based on data from the external server 101. More specifically, when the button 1415 is pressed, time information, including the start time of the highlight portion of the program and the end time thereof, is sent from the external server 101. Then, the reproduction process section of the HDD 1300 controls the reproduction process based on the time information, thereby reproducing only the highlight portion. The highlight portion is obtained by the server 101 editing the recorded program from its own viewpoint, and can be done independently of the broadcasting station 102. The user can select one of the services (web pages) provided by servers 101 that the user likes the most. An application as described above may be preferred by fans of a particular program.

After the broadcast is over, the content-reproducing web page is displayed by specifying the server 101. Another embodiment to be described below is directed to a case where the user reproduces a video recorded on the HDD 1300 without using the server 101.

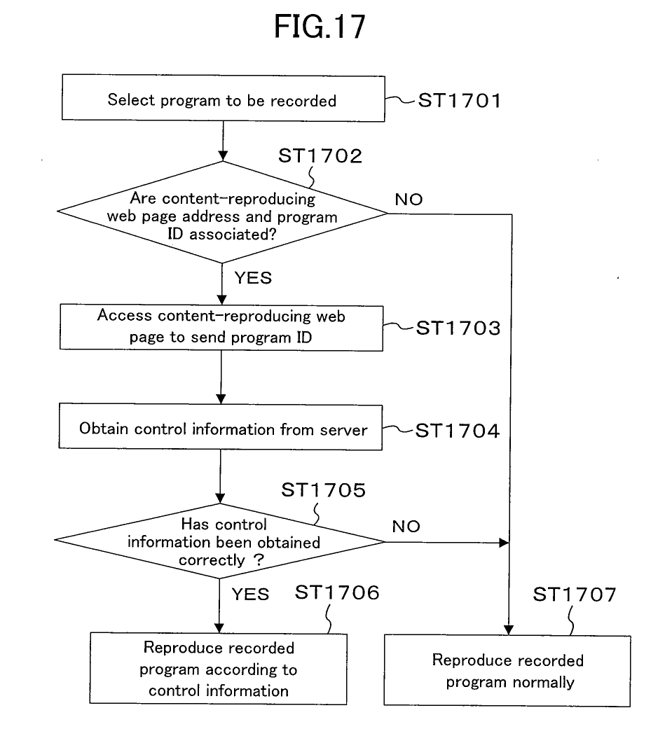

As described above, when data is recorded by using the server 101, data (FIG. 16) from the server 101 is recorded simultaneously. Information of the server 101 to be used when a video is reproduced is recorded in the data. FIG. 17 is a flow chart of the operation.

First, in step ST1701, a recorded program is selected. This selection can be made by using a recorded file name 1603 of FIG. 16.

Then, in step ST1702, it is determined whether data of FIG. 16 is associated with the recorded program that has been selected as described above. If not, the process proceeds to step ST1707 for a normal reproduction operation.

If data of FIG. 16 is associated with the recorded program, the process proceeds to step ST1703, where these data are used to access the content-reproducing web page to send the program ID. If there is any information added to the recording, such information is sent to the server 101. This can be used by the server 101 to identify each user from others. This can be used for the same purpose as that of cookies, widely used on the Internet, for example.

Then, in step ST1704, the control information 119 of the content-reproducing web page suitable for the program ID is sent from the server 101.

Then, in step ST1705, it is determined whether the control information 119 has been obtained correctly. This is for identifying a case of a timeout or a case where the server 101 is not an appropriate server for some reasons. If it is determined that the control information 119 has not been obtained correctly, the process proceeds to step ST1707 for a normal reproduction operation. If the control information 119 has been obtained correctly, the process proceeds to step ST1706 for a reproduction operation according to the control information 119.

While what is recorded in the present embodiment is a broadcast stream, the system may alternatively obtain, and record simultaneously, default control information to be used in the reproduction operation from the server 101. In such a case, if the system fails to access the server 101, pre-recorded default layout information, or the like, may be used. Moreover, the synthesized video can be recorded. This is effective when viewing the synthesized video on a device that does not have the network-link function.

As described above, the present invention makes it possible to control the existing video displaying mechanism of a device such as a receiver or a recorder based on data obtained via the network, thus making possible a wide variety of applications that could not be thought of in the prior art. What has been shown herein is merely illustrative, and content from the same broadcasting station using the same set can be freely processed by a server into a content item of a totally different look.

Data obtained from the network is not limited to image data, but may also include audio data. In such a case, sound obtained from the network may be reproduced while turning off the sound from the TV station. In such a case, the voice of a commentary may be reproduced while displaying a broadcast TV picture in a full-screen mode without providing a background image. With such a function, it is possible to realize an application for providing data that is not normally provided by a content provider, such as dialect data.

The present invention provides a system that can be connected to the network to realize various high-quality services, and provides a very significant advantage as a basic infrastructure.

What is claimed is:

1. A content providing device, comprising:
an access destination specifying portion for specifying an access destination;
a control information obtaining portion for obtaining control information via a network from the access destination specified by the access destination specifying portion;
a video content obtaining portion for obtaining video content available to an unspecified large number of people via a route other than from the access destination; and
a video content displaying portion for displaying the video content by using the control information.

2. The content providing device of claim 1, wherein the video content is broadcast video content.

3. The content providing device of claim 1, wherein the video content is video content recorded on a recording medium.

4. The content providing device of claim 1, wherein:
the control information includes information indicating a position where the video content is displayed; and
the video content displaying portion displays the video content at a position specified by the control information.

5. The content providing device of claim 4, wherein:
the control information includes image information to be displayed around the video content; and
the video content displaying portion simultaneously displays the image information around the video content.

6. The content providing device of claim 1, further comprising an overlay area determining portion for determining a predetermined area on a screen display area for displaying the video content based on predetermined information included in the video content,
wherein the video content displaying portion displays predetermined information in the area determined by the overlay area determining portion when so instructed by the control information.

7. The content providing device of claim 6, wherein the overlay area determining portion detects a position where a subpicture is displayed.

8. The content providing device of claim 2, wherein:
the control information includes information specifying a broadcast channel; and
the video content obtaining portion obtains a video from the specified channel.

9. The content providing device of claim 1, wherein:
the control information includes first audio information; and
the content providing device further comprises a portion for synthesizing second audio information included in the video content with the first audio information and providing the synthesized audio information.

10. The content providing device of claim 1, wherein the control information includes information that indicates a control to be performed when a particular event occurs.

11. The content providing device of claim 10, wherein:
the video content is broadcast video content; and
the control information includes information that indicates a control to be performed when there occurs an event relating to broadcast-related time information such as a start time and an end time of a program.

12. The content providing device of claim 10, wherein the control information includes information that instructs to make a specified network access when the event occurs.

13. The content providing device of claim 10, wherein:
the video content is recorded on a recording medium; and
in the control information, each event corresponding a reproduction control operation by a user is associated with a control operation.

14. The content providing device of claim 5, wherein:
the image information to be displayed around the video content includes a GUI; and
the control information includes information that indicates a control to be performed when the GUI is selected.

15. The content providing device of claim 14, wherein the control information includes information that instructs to make a network access to obtain new control information when the GUI is selected.

16. The content providing device of claim 1, further comprising a video content recording portion for recording corresponding video content according to the control information.

17. The content providing device of claim 16, wherein the video content recording portion records content-reproducing access destination information, which indicates an access destination to be accessed when reproducing the video content, when recording the video content, while associating the content-reproducing access destination information with the video content.

18. The content providing device of claim 17, wherein access destination information included in the control information is used as the content-reproducing access destination information.

19. The content providing device of claim 18, wherein when reproducing video content recorded by the video content recording portion, an access destination specified by the content-reproducing access destination information is accessed to obtain reproduction control information, and the video content is reproduced according to the obtained reproduction control information.

20. The content providing device of claim 1, wherein:
the video content includes information that can be transferred to outside; and
the transferable information is sent to the outside according to the control. information.

21. An image outputting device, comprising:
a separation portion for separating a main video and a subpicture from encoded video content;
a subpicture area detection portion for detecting an area where the subpicture is superimposed on the main video;
an image synthesizing portion for superimposing another image different from the subpicture on the main video in the area detected by the subpicture area detection portion to produce a synthesized image; and
an image outputting portion for outputting the synthesized image obtained by the image synthesizing portion.
